(19) United States
(12) Patent Application Publication
(10) Pub. No.: US 2007/0003090 A1
(43) Pub. Date: Jan. 4, 2007

(54) Wind noise reduction for microphone

(76) Inventor: David Anderson, Sheffield (GB)

Correspondence Address: MYERS BIGEL SIBLEY & SAJOVEC, PO BOX 37428, RALEIGH, NC, 27627, US

(21) Appl. No.: 10/559,509

(22) PCT Filed: May 25, 2004
(86) PCT No.: PCT/EP04/05605

§ 371 Date: Dec. 5, 2005

(30) Foreign Application Priority Data
Jun. 6, 2003 (EP) 030769364
Jan. 14, 2004 (EP) 040005944
Jan. 21, 2004 (US) 60537841

(51) Int. Cl. H04R 19/04

(52) U.S. Cl. 381/359

(57) ABSTRACT

The present invention relates to wind noise reduction for a microphone (10) achieved by locating a microphone pick up (2) in a chamber (4) provided with at least one sound passage (5), wherein one or more elements (s) (6) is/are provided in the sound passage (s) (5) to decrease the speed of the air stream.

### BACKGROUND OF THE INVENTION

The present invention relates to a transmitter portion of a portable electronic communication device and is concerned with reducing wind-noise produced by an undesired air stream blowing into a microphone.

Conventionally, several types of so-called “non-directional microphones” have been used in transmitters provided in portable electronic communication devices such as cellular phones. However, although these microphones are considered to be less sensitive to wind-noise from air blowing into the microphone compared to so-called “directional microphones”, wind-noise is often still a problem. Therefore, noise cancelling algorithms are sometimes used to reduce this problem. However, a drawback is that due to power consumption, noise cancelling algorithms are not always suitable in portable electronic devices having limited battery capacity.

Moreover, non-directional microphones also suffer from low signal to ambient ratio, whereby noise or background sound can negatively influence voice. Therefore, there is also a need to improve this, for instance by using a directional microphone, which has a better signal to ambient ratio compared to a non-directional microphone. However, since a directional microphone is sensitive to wind noise, to be able to use the advantage compared to a non-directional microphone, wind noise sensitivity needs to be reduced. Due to large power consumption noise cancelling algorithms are not suitable in portable devices as described above. Because of that, non-directional microphones have not found wide-spread application among portable electronic devices of today.

Thus, there is a need of a microphone, in particular a directional microphone, for a portable electronic device having low power consumption, good signal to ambient ratio, and being resistant to wind noise.

### SUMMARY OF THE INVENTION

The present invention is thus directed towards providing a microphone unit, in particular a directional microphone unit, for a portable electronic device that has low power consumption, good signal to ambient ratio, which device is resistant to wind noise.

Accordingly, an object of the invention is to provide a microphone for a telephone-transmitter to reduce wind-noise.

According to a first aspect of the invention, this is achieved by locating a microphone in a chamber provided with at least one sound passage, wherein one or more element(s) is/are provided in the sound passage(s) to decrease the speed of the air stream.

A microphone unit according to the invention includes, in front of a microphone pick up of the microphone unit a chamber. The chamber has a predetermined sectional area and volume, which together with the total sectional area and volume of the sound passages, reduces the influence of the undesired air stream.

A second aspect of the present invention is directed to a microphone unit for a portable electronic device, comprising a microphone pick up located within a microphone pick up housing forming a chamber. The chamber being provided with at least one sound passage opening for receiving sound from outside the device, wherein said at least one sound passage opening is provided with at least one wind noise reduction element.

A third aspect of the present invention is directed to a microphone unit including the aspects of the second aspect, wherein said wind reduction element comprises a mesh having one layer.

A fourth aspect of the present invention is directed to a microphone unit including the aspects of the second aspect, wherein said wind noise reduction element comprises a mesh having a plurality of layers.

A fifth aspect of the present invention is directed to a microphone unit including the aspects of the third or the fourth aspect, wherein the ratio between the chamber size and the density of the mesh is arranged to maintain the directional pick up pattern of the microphone used.

A sixth aspect of the present invention is directed to a microphone unit including the aspects of the second to the fifth aspect, wherein the mesh is made of metal.

A seventh aspect of the present invention is directed to a microphone unit including the aspects of the second to the sixth aspect, wherein the mesh is made of polymer material such as nylon.

An eighth aspect of the present invention is directed to a microphone unit including the aspects of the second to the seventh aspect, wherein said housing extending in a longitudinal direction is a cylinder having a jacket surface and a side surface.

A ninth aspect of the present invention is directed to a microphone unit including the aspects of the eight aspect, wherein said sound passage opening is a hole extending in the longitudinal direction in said mantle surface.

A tenth aspect of the present invention is directed to a microphone unit including the aspects of the eight or ninth aspect, wherein said hole is a hole in said side surface.

An eleventh aspect of the present invention is directed to a microphone unit including any one of the first to the tenth aspect, wherein said micophone unit is a directional microphone.

A twelveth aspect of the present invention is directed to a microphone unit according to any one of the first to the tenth aspects, wherein said microphone unit is non-directional.

These and other objects and advantages of the invention will be apparent from the following description taken in conjunction with the accompanying drawings.

### BRIEF DESCRIPTION OF THE DRAWINGS

FIG. 1 is a schematic sectional view, of one embodiment of the microphone unit of the invention;

FIG. 2 is a perspective view, of an embodiment of the microphone unit of the invention;

FIG. 3 is a schematic view of a mesh which was used to reduce wind-noise; and

### DESCRIPTION OF THE PREFERRED EMBODIMENTS

The present invention can be advantageously applied to all types of microphones to reduce sensitivity to wind-noise. Wind-noise is a significant problem particularly in directional microphones, which are more sensitive to this disturbance. Accordingly, the invention will be described with reference to a preferred embodiment in which an electret condenser type directional microphone is used, but is not in any sense limited thereto.

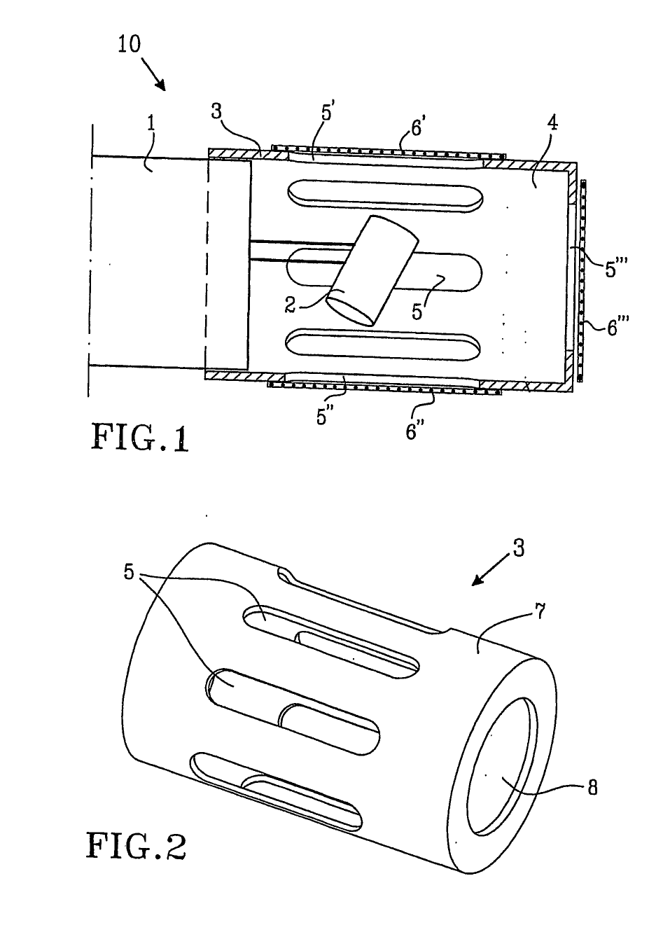

In FIG. 1 a main part 1 of a cellular phone transmitter unit is provided with a directional microphone pick up 2. The microphone pick up 2 is surrounded by a pick up housing 3 forming a chamber 4 having a predetermined cross-sectional area and a predetermined volume, which chamber 4 encloses the microphone pick up 2. The chamber 4 includes at least one sound passage opening 5, preferably a plurality of sound passage openings 5, 5′, 5″, each opening 5′, 5″, 5″′ provided with a wind noise reduction element 6. The number of wind noise reduction elements 6′, 6″, 6″′ can be any suitable number and is by no means limited to a particular number. The microphone pick up 2, the housing 3, the sound passage openings 5′, 5″, 5″′ and the noise reduction element 6′, 6″, 6″′ all together provide a directional microphone unit 10, which can be positioned in connection to a mouthpiece (not shown) provided in a front panel (not shown) of a portable electronic device (not shown). This is not shown in more detail since it is well known for a person skilled in the art of portable electronic devices.

Now is referred also to FIG. 2. Preferably, the housing 3 has the shape of a cylinder, provided with a number of relatively large sound passage openings (holes) arranged in all directions, for instance extending in a longitudinally direction of a jacket surface 7. Preferably, there is also provided a sound passage 5 opening in a side surface 8.

In a microphone unit 10 according to the invention, part of the air stream which includes wind-noise is interrupted or blocked by the mouthpiece (not shown), and part is able to pass through the sound passage openings 5, 5′, 5″ to enter the chamber 4. Because of the interaction bewteen chamber 4 volume, openings 5, 5′, 5″ and wind noise reduction element 6, the air particle velocity, forming the wind, is not easily able to enter the chamber and produce wind-noise in the microphone pick up unit.

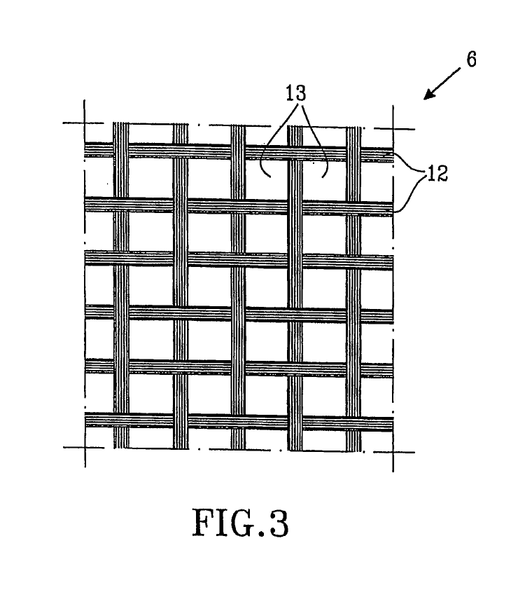

Now is referred to FIG. 3. The wind noise reduction element 6 could for instance comprise one single layer such as a mesh made of metal, or polymer material. The mesh can be of conventional type comprising wires 12 with openings 13. The mesh can also be made of textile fabrics such as cotton fabric or the like.

Typically, the ratio between the chamber size and the density of the mesh is arranged to maintain a desired level of directionality from the microphone pick up unit. Similarly the cross-sectional area and volume of the chamber may be determined experimentally to achieve the desired reduction in wind-noise.

Because the sensitivity of a microphone with respect to an air stream has, in general, a proportional relationship with the speed of the impinging air stream, it has been found that by decreasing the speed of the air stream as just described, wind-noise due to the air stream can be reduced to an almost negligible level. However, it has been found that the sound or speaking voice signal or sound wave is transmitted in a normal manner so that the reproduced speaking voice is not adversely affected.

Accordingly, it is seen that the inventive microphone unit provides greatly reduced sensitivity to wind-noise, is non-expensive, since no electronics or software is required, and offer good overall frequency response characteristics. The microphone unit is small in size, typically two to three times the size of the miniature microphone capsule. The reduction can vary from 15-30 dB depending on the amount of directionality that must be maintained. More reduction implies less directionality.

Although the invention has been described with reference to particular preferred embodiments, it is to be understood by those skilled in the art that various changes and modifications can be made without departing from the spirit and scope of the invention.

1. Microphone unit for mobile equipment, comprising:
a microphone pick up located within a microphone pick up housing forming a chamber, wherein said housing extending in a longitudinally direction is a cylinder having a shielding surface and a side surface, wherein characterized in that said housing is provided with three sound passage openings for receiving sound from a sound field external to said chamber, said sound passage openings being provided with at least one wind noise reduction element each.

2. Mirophone unit according to claim 1, wherein said wind noise reduction element comprises a mesh having one layer.

3. Microphone unit according to claim 1, wherein said wind noise reduction element comprises a mesh having a plurality of layers.

4. Microphone unit according to claim 1, wherein the mesh is made of metal.

5. Microphone unit according to claim 1, wherein the mesh is made of polymer material such as nylon.

6. Microphone unit according to claim 5, wherein said sound passage opening is a hole extending in the longitudinally direction in said shielding surface.

7. Microphone unit according to claim 5, wherein said sound passage opening is a hole in said side surface.
